(19) United States
(12) Patent Application Publication
(10) Pub. No.: US 2025/0348767 A1
(43) Pub. Date: Nov. 13, 2025

(54) INFORMATION PROCESSING APPARATUS, INFORMATION PROCESSING METHOD, AND STORAGE MEDIUM

(71) Applicant: NEC Corporation, Tokyo (JP)

(72) Inventor: Kei TAKEMURA, Tokyo (JP)

(73) Assignee: NEC Corporation, Tokyo (JP)

(21) Appl. No.: 19/200,814

(22) Filed: May 7, 2025

(30) Foreign Application Priority Data
May 10, 2024 (JP) 2024-077388

(51) Int. Cl. G06N 5/043

(52) U.S. Cl. CPC G06N 5/043

(57) ABSTRACT

An information processing apparatus includes at least one processor that carries out: a setting process of setting a reliability for an expert; a first calculation process of normalizing the reliability to calculate a normalized reliability; an updating process of updating the normalized reliability with reference to a loss value; and a second calculation process of subjecting the updated normalized reliability to scaling. In the setting process, as a reliability of a new expert, the at least one processor sets a predetermined value, and as a reliability of an existing expert, the at least one processor set the scaled reliability.

This Nonprovisional application claims priority under 35 U.S.C. § 119 on Patent Application No. 2024-077388 filed in Japan on May 10, 2024, the entire contents of which are hereby incorporated by reference.

### TECHNICAL FIELD

The present disclosure relates to an information processing apparatus, an information processing method, and a storage medium.

### BACKGROUND ART

A technique of carrying out prediction (decision making) using multiple experts is disclosed.

For example, Patent Literature 1 discloses an elevator traffic demand prediction apparatus for selecting a control scheme in accordance with a prediction result generated by a prediction section including an expert that predicts a category of an elevator traffic demand and generates a predicted value.

### CITATION LIST

### Patent Literature

[Patent Literature 1] Japanese Patent Application Publication Tokukai No. 2014-172718

### SUMMARY OF INVENTION

### Technical Problem

A technique of making decisions is required to make appropriate decisions (in other words, making decisions with minimal loss) even in a case where the environment varies. Thus, it is required to add or remove an expert in accordance with environmental changes. However, in the elevator traffic demand prediction apparatus disclosed in Patent Literature 1, adding or removing an expert is not considered.

The present disclosure has been made in view of this problem, and an example object thereof is to provide a decision making technique suitably reacting to addition or removal of an expert.

### Solution to Problem

An information processing apparatus in accordance with an example aspect of the present disclosure includes at least one processor, the at least one processor carrying out: a setting process of setting a reliability for each of a plurality of experts; a first calculation process of normalizing the reliability of each of the plurality of experts, to calculate a normalized reliability; an updating process of updating the normalized reliability of each of the plurality of experts with reference to a loss value of the expert obtained in a case where prediction is performed applying the normalized reliability; and a second calculation process of subjecting the updated normalized reliability of each of the plurality of experts to scaling, to calculate a scaled reliability, wherein in the setting process, as a reliability of a newly added new expert, the at least one processor sets a predetermined value, and as a reliability of an existing expert, the at least one processor sets the scaled reliability.

An information processing method in accordance with an example aspect of the present disclosure includes: a setting process of setting, by at least one processor, a reliability for each of a plurality of experts; a first calculation process of normalizing, by the at least one processor, the reliability of each of the plurality of experts, to calculate a normalized reliability; an updating process of updating, by the at least one processor, the normalized reliability of each of the plurality of experts with reference to a loss value of the expert obtained in a case where prediction is performed applying the normalized reliability; and a second calculation process of subjecting, by the at least one processor, the updated normalized reliability of each of the plurality of experts to scaling, to calculate a scaled reliability, wherein in the setting process, the at least one processor sets, as a reliability of a newly added new expert, a predetermined value, and sets, as a reliability of an existing expert, the scaled reliability.

A computer-readable non-transitory storage medium that stores an information processing program that causes an information processing computer in accordance with an example aspect of the present disclosure, to function as an information processing apparatus, the program causing the computer to carry out: a setting process of setting a reliability for each of a plurality of experts; a first calculation process of normalizing the reliability of each of the plurality of experts, to calculate a normalized reliability; an updating process of updating the normalized reliability of each of the plurality of experts with reference to a loss value of the expert obtained in a case where prediction is performed applying the normalized reliability; and a second calculation process of subjecting the updated normalized reliability of each of the plurality of experts to scaling, to calculate a scaled reliability, wherein in the setting process, as a reliability of a newly added new expert, a predetermined value is set, and as a reliability of an existing expert, the scaled reliability is set.

### Advantageous Effects of Invention

According to an example aspect of the present disclosure, it is possible to achieve an example advantage of being capable of providing a decision making technique suitably reacting to addition or removal of an expert.

### BRIEF DESCRIPTION OF DRAWINGS

FIG. 1 is a block diagram illustrating the configuration of an information processing apparatus in accordance with the present disclosure.

FIG. 2 is a diagram illustrating the outline of an information processing apparatus in accordance with the present disclosure.

FIG. 3 is a flowchart illustrating the flow of an information processing method in accordance with the present disclosure.

FIG. 4 is a block diagram illustrating the configuration of an information processing apparatus in accordance with the present disclosure.

FIG. 5 is a flowchart illustrating the flow of an information processing method in accordance with the present disclosure.

FIG. 6 is a graph illustrating the performance of an information processing apparatus in accordance with the present disclosure.

FIG. 7 is a block diagram illustrating the configuration of a computer that functions as the information processing apparatuses in accordance with the present disclosure.

### EXAMPLE EMBODIMENTS

Example embodiments of the present invention will be described below by way of example. It should be noted that the present invention is not limited to the example embodiments described below, but may be altered in various ways by a skilled person within the scope of the claims. For example, any example embodiment derived by appropriately combining technical means employed in the example embodiments described below can be within the scope of the present invention. Further, any example embodiment derived from appropriately omitting some of the technical means employed in the example embodiments described below can also be within the scope of the present invention. Furthermore, an example advantage to which reference is made in each of the example embodiments described below is an example of the advantage expected in that example embodiment, and does not define the extension of the present invention. Therefore, any example embodiment which does not provide the example advantage to which reference is made in each of the example embodiments described below can also be within the scope of the present invention.

### First Example Embodiment

A first example embodiment, which is an example of an embodiment of the present invention, will be described in detail with reference to the drawings. The present example embodiment is a basic form of each example embodiment discussed later. It should be noted that the scope of an application of technical means employed in the present example embodiment is not limited to the present example embodiment. That is, each technical means employed in the present example embodiment can be employed also in another example embodiment included in the present disclosure, provided that no particular technical problems occur. In addition, each technical means indicated in the drawings referred to for discussing the present example embodiment can be employed also in another example embodiment included in the present disclosure, provided that no particular technical problems occur.

### (Outline of Information Processing Apparatus 1)

An information processing apparatus 1 is an apparatus that obtains data from each of a plurality of experts and makes a decision with use of the data. The information processing apparatus 1 sequentially makes decisions with use of the data.

An example of the “expert” in the present disclosure may be a value that varies with time (e.g., a stock price). Another example of the “expert” may be hardware such as a predicted value derivation apparatus configured to output a predicted value. Yet another example of the “expert” may be software (also referred to as “model” or “agent”) such as a predicted value derivation algorithm configured to output a predicted value. Yet another example of the “expert” may be a living body (e.g., person) capable of outputting a predicted value by some method.

The information processing apparatus 1 obtains (or calculates) a loss value in decision making with use of data from the “expert”. As an example, the “loss value” may be expressed, but not limited to in the present disclosure, as a difference between the data from the “expert” and an observed value (actually measured value). The “loss value” may be a difference between the data from the “expert” and another predetermined value. The “loss value” may be an estimate related to loss. Further, the term “loss value” may include the concept of “reward”. For example, the loss value may also be expressed as one obtained by inverting the sign of the reward value (i.e., the reward value multiplied by a negative constant). Therefore, the loss value in the present disclosure may be read as a reward value. Note that the present disclosure is not limited to the information referred to in calculation of the loss value and the specific algorithm for calculating the loss value.

In the present disclosure, the “decision” refers to any information about an event of interest, and is not limited to decisions made by a living body (person). For example, in an application scene in which a portfolio obtained by combining stocks of multiple companies is predicted, a predicted value related to a future portfolio is an example of “decision” made by the information processing apparatus 1 or “decision making result” derived by the information processing apparatus 1. In the present disclosure, as a result of decision making carried out by the information processing apparatus 1, a case of a predicted value will be described as an example. The information processing apparatus 1 may also be expressed as a decision making apparatus, a decision making result derivation apparatus, or the like. Here, “decision making result” may also be referred to as “optimization solution” or “optimization result”.

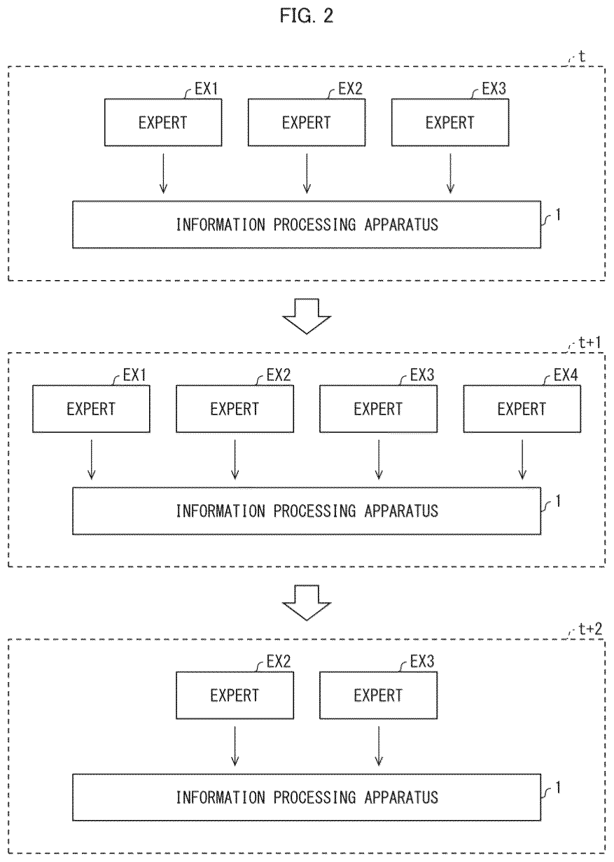

Further, in the information processing apparatus 1, the number of experts from which data is obtained is not limited. The number of experts will be described with reference to FIG. 2. FIG. 2 is a diagram illustrating the outline of the information processing apparatus 1.

As illustrated on the upper side of FIG. 2, the information processing apparatus 1 in round t obtains data from each of the experts EX1, EX2, and EX3. That is, the number of experts EX in the round t is 3. The information processing apparatus 1 carries out decision making in the round t with use of data obtained from each of the three experts EX.

Next, as illustrated at the center of FIG. 2, the information processing apparatus 1 in round t+1 obtains data from an expert EX4, in addition to the experts EX1, EX2, and EX3. That is, the number of experts EX in the round t+1 is 4, which is obtained by adding 1 to 3 of the round t. The information processing apparatus 1 carries out decision making in the round t+1 with use of data obtained from each of the four experts EX.

Subsequently, as illustrated on the lower side of FIG. 2, the information processing apparatus 1 in round t+2 obtains data from each of the experts EX2 and EX3 from among the abovementioned experts EX. That is, the number of experts EX in the round t+2 is 2, which is obtained by deleting 2 from 4 of the round t+1. The information processing apparatus 1 carries out decision making in the round t+2 with use of data obtained from each of the two experts EX.

Thus, even in a case where an expert is added or removed, the information processing apparatus 1 makes a decision regardless of the number of experts.

### (Configuration of Information Processing Apparatus 1)

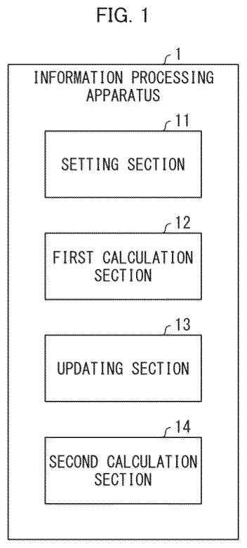

The following description will discuss the configuration of an information processing apparatus 1 with reference to FIG. 1. FIG. 1 is a block diagram illustrating the configuration of the information processing apparatus 1. As illustrated in FIG. 1, the information processing apparatus 1 includes a setting section 11, a first calculation section 12, an updating section 13, and a second calculation section 14. The setting section 11, the first calculation section 12, the updating section 13, and the second calculation section 14 are configured to realize setting means, first calculation means, updating means, and second calculation means, respectively, in accordance to the present example embodiment.

### (Setting Section 11)

The setting section 11 sets a reliability for each of a plurality of experts. Herein, the reliability is an index indicating how much the predicted value obtained by each expert is reflected in the decision making processing.

Further, the setting section 11 sets a predetermined value as the reliability of a newly added new expert (e.g., expert EX4 in the round t+1 in FIG. 2 described above), and sets the scaled reliability, subjected to scaling by the second calculation section 14, which will be described later, as the reliability of an existing expert.

The setting section 11 supplies the set reliabilities to the first calculation section 12.

### (First Calculation Section 12)

The first calculation section 12 normalizes the reliability of each of the plurality of experts, to calculate a normalized reliability. The first calculation section 12 supplies the calculated normalized reliabilities to the updating section 13.

### (Updating Section 13)

The updating section 13 updates the normalized reliability of each of the plurality of experts with reference to a loss value of the expert obtained in a case where prediction is performed applying the normalized reliability calculated by the first calculation section 12. The updating section 13 supplies the updated normalized reliabilities to the second calculation section 14.

### (Second Calculation Section 14)

The second calculation section 14 subjects the updated normalized reliability of each of the plurality of experts, updated by the updating section 13, to scaling, to calculate a scaled reliability.

### (Example Advantage of Information Processing Apparatus 1)

As described in the foregoing, the information processing apparatus 1 employs a configuration in which the apparatus includes: the setting section 11 that sets a reliability for each of a plurality of experts; the first calculation section 12 that normalizes the reliability of each of the plurality of experts, to calculate a normalized reliability; the updating section 13 that updates the normalized reliability of each of the plurality of experts with reference to a loss value of the expert obtained in a case where prediction is performed applying the normalized reliability calculated by the first calculation section 12; and the second calculation section 14 that subjects the updated normalized reliability of each of the plurality of experts, updated by the updating section 13, to scaling, to calculate a scaled reliability.

Further, in the information processing apparatus 1, the setting section 11 sets a predetermined value as the reliability of a newly added new expert, and sets the scaled reliability, subjected to scaling by the second calculation section 14, as the reliability of an existing expert.

Therefore, according to the information processing apparatus 1, it is possible to provide a decision making technique suitably reacting to addition or removal of an expert.

### (Flow of Information Processing Method S1)

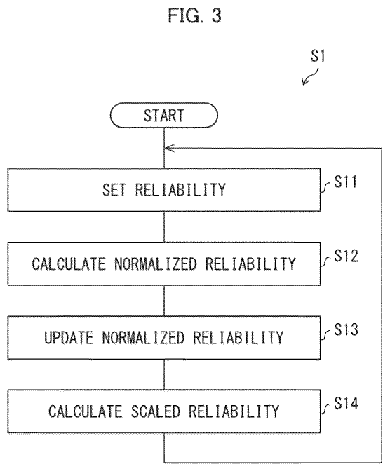

The following description will discuss the flow of an information processing method S1 with reference to FIG. 3. FIG. 3 is a flowchart illustrating the flow of the information processing method S1. As illustrated in FIG. 3, the information processing method S1 includes a setting process S11, a normalized reliability calculation process S12 (first calculation process S12), an updating process S13, and a reliability calculation process S14 (second calculation process S14).

### (Setting Process S11)

In the setting process S11, the setting section 11 sets a reliability for each of a plurality of experts. The setting section 11 supplies the set reliabilities to the first calculation section 12.

### (Normalized Reliability Calculation Process S12)

In the normalized reliability calculation process S12, the first calculation section 12 normalizes the reliability of each of the plurality of experts, to calculate a normalized reliability. The first calculation section 12 supplies the calculated normalized reliabilities to the updating section 13.

### (Updating Process S13)

In the updating process S13, the updating section 13 updates the normalized reliability of each of the plurality of experts with reference to a loss value of the expert obtained in a case where prediction is performed applying the normalized reliability calculated by the first calculation section 12. The updating section 13 supplies the updated normalized reliabilities to the second calculation section 14.

### (Reliability Calculation Process S14)

In the reliability calculation process S14, the second calculation section 14 subjects the updated normalized reliability of each of the plurality of experts, updated by the updating section 13, to scaling, to calculate a scaled reliability.

### (Setting Process S11)

Again in the setting process S11, the setting section 11 sets a predetermined value as the reliability of a newly added new expert, and sets the scaled reliability, subjected to scaling by the second calculation section 14 in the reliability calculation process S14, as the reliability of an existing expert.

Thus, by repeatedly carrying out the processing from the setting process S11 to the reliability calculation process S14, the information processing apparatus 1 sequentially makes decisions with use of data.

### (Example Advantage of Information Processing Method S1)

As described in the foregoing, the information processing method S1 employs a configuration in which the method includes: the setting process S11 of setting, by the setting section 11, a reliability for each of a plurality of experts; the normalized reliability calculation process S12 of normalizing, by the first calculation section 12, the reliability of each of the plurality of experts, to calculate a normalized reliability; the updating process S13 of updating, by the updating section 13, the normalized reliability of each of the plurality of experts with reference to a loss value of the expert obtained in a case where prediction is performed applying the normalized reliability calculated by the first calculation section 12; and the reliability calculation process S14 of subjecting, by the second calculation section 14, the updated normalized reliability of each of the plurality of experts, updated by the updating section 13, to scaling, to calculate a scaled reliability.

Further, in the information processing method S1, in the setting process S11, the setting section 11 sets a predetermined value as the reliability of a newly added new expert, and sets the scaled reliability, subjected to scaling b the second calculation section 14 in the reliability calculation process S14, as the reliability of an existing expert.

Thus, with the information processing method S1, it is possible to achieve an example advantage similar to that achieved by the information processing apparatus 1 described above.

### Second Example Embodiment

A second example embodiment, which is an example of the embodiment of the present invention, will be described in detail with reference to the drawings. The same reference symbols are given to constituent elements which have functions identical to those described in the above example embodiment, and descriptions as to such constituent elements are omitted as appropriate. It should be noted that the scope of an application of technical means employed in the present example embodiment is not limited to the present example embodiment. That is, each technical means employed in the present example embodiment can be employed also in another example embodiment included in the present disclosure, provided that no particular technical problems occur. In addition, each technical means illustrated in each drawing referred to for discussing the present example embodiment can be employed also in another example embodiment included in the present disclosure, provided that no particular technical problems occur.

### (Configuration of Information Processing Apparatus 1A)

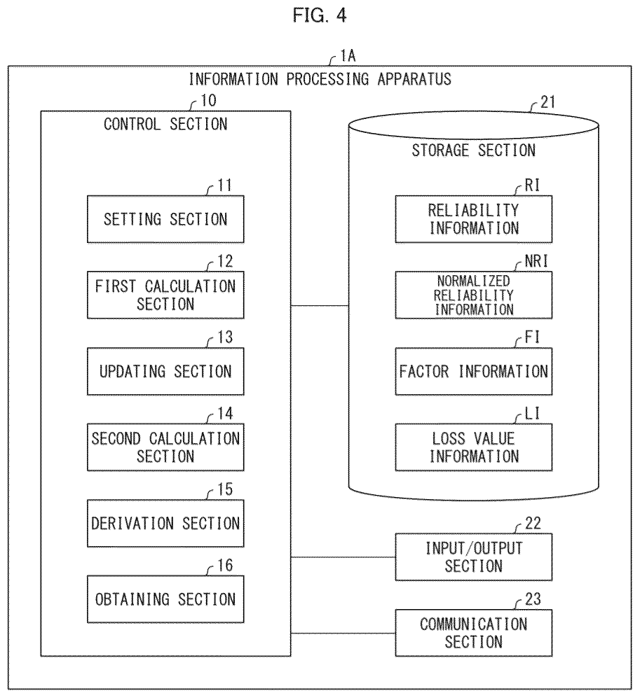

The following description will discuss the configuration of an information processing apparatus 1A with reference to FIG. 4. FIG. 4 is a block diagram illustrating the configuration of the information processing apparatus 1A. As illustrated in FIG. 4, the information processing apparatus 1A includes a control section 10, a storage section 21, an input/output section 22, and a communication section 23.

### (Storage Section 21)

The storage section 21 stores data referred to by the control section 10. Examples of the storage section 21 may include, but not limited to, a flash memory, a hard disk drive (HDD), a solid state drive (SSD), and a combination thereof.

Examples of data stored in the storage section 21 may include, as illustrated in FIG. 4, but not limited to, reliability information RI that indicates each of a plurality of experts EX and the set reliability thereof, normalized reliability information NRI that indicates each of the plurality of experts EX and the normalized reliability thereof, factor information FI that indicates a factor for use in the normalization, and loss value information LI that indicates a loss value of each of the plurality of experts. Examples of these pieces of data will be described later.

### (Input/Output Section 22)

The input/output section 22 is an interface for receiving data input and for outputting data. Examples of the input/output section 22 may include, but not limited to, a microphone, a camera, a gaze input device, a keyboard, a touch pad, a speaker, and a liquid crystal display.

### (Communication Section 23)

The communication section 23 is an interface for performing transmission and reception of data via a network. Examples of the communication section 23 may include, but not limited to, a communication chip in various communication standards such as Ethernet (registered trademark), Wireless Fidelity (Wi-Fi, registered trademark), and radio communications standard for mobile data communications networks, and a USB-compliant connector.

### (Control Section 10)

The control section 10 controls constituent elements included in the information processing apparatus 1A. As illustrated in FIG. 4, the control section 10 includes a setting section 11, a first calculation section 12, an updating section 13, a second calculation section 14, a derivation section 15, and an obtaining section 16. The setting section 11, the first calculation section 12, the updating section 13, and the second calculation section 14 are configured to realize setting means, first calculation means, updating means, and second calculation means, respectively, in accordance to the present example embodiment. An example of processing of each section will be described later.

### (Setting Section 11)

The setting section 11 sets a reliability for each of a plurality of experts EX. For example, in the upper diagram of FIG. 2 described above, the setting section 11 sets a reliability for each of the experts EX1, EX2, and EX3.

As an example, the setting section 11 sets, as the reliabilities of the existing experts EX, the scaled reliabilities, subjected to scaling by the second calculation section 14, which will be described later. For example, as illustrated on the upper side of FIG. 2, the setting section 11 in the round t sets the scaled reliabilities, subjected to scaling by the second calculation section 14, described latter, in round t−1, not illustrated in FIG. 2, for the respective experts EX1, EX2, and EX3.

As another example, the setting section 11 sets a predetermined value as the reliability of a newly added new expert. For example, as illustrated at the center of FIG. 2, a predetermined value is set as the reliability of the new expert EX4 added in the round t+1. Although the predetermined value is not particularly limited, a case where the predetermined value is “1” will be described in the present example embodiment.

Further, as described above, in the round t+1, the setting section 11 sets the scaled reliabilities, subjected to scaling by the second calculation section 14 in the round t, as the reliabilities of the respective experts EX1, EX2, and EX3.

The setting section 11 stores the experts EX and the reliabilities set for the respective experts EX as the reliability information RI, in the storage section 21.

### (First Calculation Section 12)

The first calculation section 12 normalizes the reliability of each of the plurality of experts EX, to calculate a normalized reliability.

For example, the first calculation section 12 calculates, with reference to the reliability information RI stored in the storage section 21, the sum of the reliabilities set for the respective experts EX indicated in the reliability information RI. Then, the first calculation section 12 normalizes the reliability of each of the plurality of experts EX with use of a reciprocal of the calculated sum as a factor. The first calculation section 12 stores the experts EX and the normalized reliabilities corresponding to the respective experts EX as the normalized reliability information NRI, in the storage section 21. The first calculation section 12 stores the factor information FI that indicates the factor in the storage section 21.

### (Updating Section 13)

The updating section 13 updates the normalized reliability of the each of the plurality of experts EX with reference to a loss value of the expert EX obtained in a case where prediction is performed applying the normalized reliability.

For example, the updating section 13 updates the normalized reliability information NRI stored in the storage section 21 with reference to the loss value indicated in the loss value information LI, which will be described later. Examples of a method in which the updating section 13 updates the normalized reliabilities may include, but not limited to, a method in which Multi-scale Multiplicative-weight with Correction (MsMwC) is used.

### (Second Calculation Section 14)

The second calculation section 14 subjects the updated normalized reliability of each of the plurality of experts EX to scaling, to calculate a scaled reliability.

For example, the second calculation section 14 calculates the scaled reliabilities with reference to the factor information FI stored in the storage section 21. As an example, the second calculation section 14 performs scaling with use of a reciprocal of a factor indicated in the factor information FI (that is, a factor used by the first calculation section 12 in the normalization). With this configuration, the second calculation section 14 can perform scaling to obtain the reliabilities before being normalized by the first calculation section 12.

### (Derivation Section 15)

The derivation section 15 derives a predicted value (decision making result) by applying the normalized reliabilities. The derivation section 15 may store the derived predicted value in the storage section 21 or may output it via the input/output section 22 or the communication section 23.

### (Obtaining Section 16)

The obtaining section 16 obtains data via the input/output section 22 or the communication section 23. An example of the data obtained by the obtaining section 16 may be data from each of the plurality of experts EX.

Another example of the data obtained by the obtaining section 16 may be a loss value. The obtaining section 16 may be configured to obtain a loss value from another apparatus, or alternatively, the obtaining section 16 may obtain an observed value (actually measured value), calculate a difference from the predicted value derived by the derivation section 15, and obtain a loss value. The obtaining section 16 stores the loss value information LI that indicates the obtained loss value in the storage section 21.

### (First Example of Flow of Processing Carried Out by Information Processing Apparatus 1A)

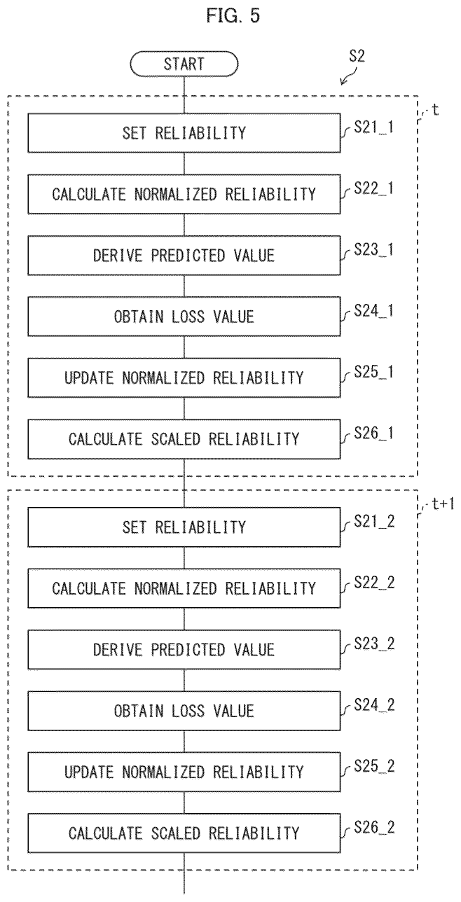

The following description will discuss the flow of processing carried out by the information processing apparatus 1A (information processing method S2) with reference to FIG. 5. FIG. 5 is a flowchart illustrating the flow of the information processing method S2. As illustrated in FIG. 5, steps S21_1 to S26_1 are the flow of processing carried out by the information processing apparatus 1A in the round t, and steps S21_2 to S26_2 are the flow of processing carried out by the information processing apparatus 1A in the round t+1. First, the flow of processing carried out by the information processing apparatus 1A in the round t will be described.

### (Step S21_1)

In step S21_1, the setting section 11 sets a reliability for each of a plurality of experts. As an example, the setting section 11 sets the reliability for each of the experts EX1, EX2, and EX3 illustrated in FIG. 2 as follows.

Reliability “0.6” Expert EX1:

Reliability “0.8” Expert EX2:

Reliability “0.6” Expert EX3:

As described above, the setting section 11 may set, for each of the experts EX1, EX2, and EX3, the scaled reliability, subjected to scaling by the second calculation section 14 in round t−1, which is the round immediately before the round t.

The setting section 11 stores the reliability information RI that indicates the experts EX and the reliabilities set for the respective experts EX, in the storage section 21.

### (Step S22_1)

In step S22_1, with reference to the reliability information RI stored in the storage section 21, the first calculation section 12 normalizes the reliability of each of the plurality of experts EX, to calculate a normalized reliability.

In the example described above, the first calculation section 12 first calculates the sum of the reliabilities (0.6+0.8+0.6=2.0). Next, the first calculation section 12 calculates products obtained by multiplying each of the reliabilities by a factor, which is a reciprocal of the calculated sum, to obtain normalized reliabilities, as follows.

Normalized reliability=0.6×(1/2)=“0.3” Expert EX1:

Normalized reliability=0.8×(1/2)=“0.4” Expert EX2:

Normalized reliability=0.6×(1/2)=“0.3” Expert EX3:

The first calculation section 12 stores the normalized reliability information NRI that indicates the experts EX and the normalized reliabilities corresponding to the respective experts EX, in the storage section 21. The first calculation section 12 stores factor information that indicates the factor used in the normalization, in the storage section 21.

### (Step S23_1)

In step S23_1, the derivation section 15 derives a predicted value by applying the normalized reliabilities with reference to the normalized reliability information NRI stored in the storage section 21. The derivation section 15 stores the derived predicted value in the storage section 21, or outputs it via the input/output section 22 or the communication section 23.

### (Step S24_1)

In step S24_1, the obtaining section 16 obtains loss values. As described above, the obtaining section 16 may obtain loss values via the input/output section 22 or the communication section 23, or may obtain loss values by obtaining observed values and calculating the loss values therefrom. The obtaining section 16 stores the loss value information LI that indicates the loss values in the storage section 21.

### (Step S25_1)

In step S25_1, the updating section 13 updates the normalized reliability of each expert EX with reference to the loss value of the expert EX indicated in the loss value information LI stored in the storage section 21. For example, the updating section 13 updates the normalized reliabilities to the following values.

Normalized reliability=“0.35” Expert EX1:

Normalized reliability=“0.45” Expert EX2:

Normalized reliability=“0.2” Expert EX3:

The updating section 13 updates the normalized reliability information NRI stored in the storage section 21.

### (Step S26_1)

In step S26_1, the second calculation section 14 subjects the updated normalized reliability of each expert EX with reference to the normalized reliability information NRI and the factor information FI stored in the storage section 21, to calculate a scaled reliability. In the example described above, for each expert EX, the second calculation section 14 multiplies the updated normalized reliability of the expert EX by the reciprocal of the factor (i.e., 2, which is a reciprocal of 1/2), to calculate the following scaled reliabilities.

Scaled reliability=0.35×2=“0.7” Expert EX1:

Scaled reliability=0.45×2=“0.9” Expert EX2:

Scaled reliability=0.2×2=“0.4” Expert EX3:

Next, the flow of processing carried out by the information processing apparatus 1A in the round t+1 will be described. Hereunder, as an example, a case where an expert EX4 is added in the round t+1 as illustrated at the center of FIG. 2 described above, will be described.

### (Step S21_2)

In step S21_2, the setting section 11 sets, for each of the existing experts EX1, EX2, and EX3, the scaled reliability that has been obtained in step S26_1, as follows.

Reliability “0.7” Expert EX1:

Reliability “0.9” Expert EX2:

Reliability “0.4” Expert EX3:

In addition, in step S21_2, the setting section 11 also sets a predetermined value “1.0” as the reliability of the newly added new expert EX4.

Reliability “1.0” Expert EX4:

The setting section 11 stores the reliability information RI that indicates the experts EX and the reliabilities set for the respective experts EX, in the storage section 21.

### (Step S22_2)

In step S22_2, the first calculation section 12 calculates, with reference to the reliability information RI stored in the storage section 21, the sum of the reliabilities (0.7+0.9+0.4+1=3), similarly to step S22_1 described above. Then, the first calculation section 12 calculates products obtained by multiplying each of the reliabilities by a factor, which is a reciprocal of the calculated sum, to obtain normalized reliabilities.

Normalized reliability=0.7×(1/3)=“0.23” Expert EX1:

Normalized reliability=0.9×(1/3)=“0.30” Expert EX2:

Normalized reliability=0.4×(1/3)=“0.13” Expert EX3:

Normalized reliability=1.0×(1/3)=“0.34” Expert EX4:

The first calculation section 12 stores the normalized reliability information NRI that indicates the experts EX the and normalized reliabilities corresponding to the respective experts EX, in the storage section 21. The first calculation section 12 stores factor information that indicates the factor used in the normalization, in the storage section 21.

### (Step S23_2)

In step S23_2, similarly to step S23_1 described above, the derivation section 15 derives a predicted value by applying the normalized reliabilities with reference to the normalized reliability information NRI stored in the storage section 21. The derivation section 15 stores the derived predicted value in the storage section 21, or outputs it via the input/output section 22 or the communication section 23.

### (Step S24_2)

In step S24_2, the obtaining section 16 obtains loss values, similarly to step S24_1 described above. The obtaining section 16 stores the loss value information LI that indicates the loss values in the storage section 21.

### (Step S25_2)

In step S25_2, similarly to step S25_1 described above, the updating section 13 updates the normalized reliability of each expert EX with reference to the loss value of the expert EX indicated in the loss value information LI stored in the storage section 21. For example, the updating section 13 updates the normalized reliabilities to the following values.

Normalized reliability=“0.25” Expert EX1:

Normalized reliability=“0.32” Expert EX2:

Normalized reliability=“0.10” Expert EX3:

Normalized reliability=“0.33” Expert EX4:

The updating section 13 updates the normalized reliability information NRI stored in the storage section 21.

### (Step S26_2)

In step S26_2, similarly to step S26_1 described above, the second calculation section 14 subjects the updated normalized reliability of each expert EX with reference to the normalized reliability information NRI and the factor information FI stored in the storage section 21, to calculate a scaled reliability.

Scaled reliability=0.25×3=0.75 Expert EX1:

Scaled reliability=0.32×3=0.96 Expert EX2:

Scaled reliability=0.10×3=0.30 Expert EX3:

Scaled reliability=0.33×3=0.99 Expert EX4:

As described above, in a case where the expert EX4 is added, the information processing apparatus 1A sets a predetermined value as the reliability of the expert EX4. Then, the information processing apparatus 1A normalizes this reliability together with the reliabilities of the other experts EX, and derives (decision making) a predicted value with use of the normalized reliabilities. Further, the information processing apparatus 1A performs scaling of the updated reliabilities, sets the scaled reliabilities as the reliabilities of the respective experts EX, and normalizes the set reliabilities again. Then, the information processing apparatus 1A repeats the process of deriving a predicted value using the normalized reliabilities.

Therefore, even in a case where the expert EX4 is added, the information processing apparatus 1A can derive a predicted value suitably reacting to the addition of the expert EX4 by repeating the normalization of the reliabilities and the scaling of the normalized reliabilities updated. Further, the information processing apparatus 1A can derive a predicted value suitably reacting to the addition of the expert EX4, without recognizing the total number of experts EX.

### (Second Example of Flow of Processing Carried Out by Information Processing Apparatus 1A)

Hereunder, an example of the flow of processing carried out by the information processing apparatus 1A in round t+2 (not illustrated in FIG. 5) will be described. Also in the round t+2, similarly to the rounds t and t+1 described above, the processing described in the flowchart illustrated in FIG. 5 is carried out. In the round t+2, as illustrated on the lower side of FIG. 2 described above, a case where the experts EX1 and EX4 have been deleted will be described. Steps S21_2 to S26_2, which are processes in the round t+1, are as described above.

### (Step S21_3)

In step S21_3, the setting section 11 sets, for each of the existing experts EX2 and EX3, the scaled reliability that has been obtained in step S26_2, as follows.

Reliability “0.96” Expert EX1:

Reliability “0.30” Expert EX2:

The setting section 11 stores the reliability information RI that indicates the experts EX and the reliabilities set for the respective experts EX, in the storage section 21.

### (Step S22_3)

In step S22_3, the first calculation section 12 calculates, with reference to the reliability information RI stored in the storage section 21, the sum of the reliabilities (0.96+0.30=1.26), similarly to step S22_1 described above. Then, the first calculation section 12 calculates products obtained by multiplying each of the reliabilities by a factor, which is a reciprocal of the calculated sum, to obtain normalized reliabilities.

Normalized reliability=0.96×(1/1.26)=“0.76” Expert EX2:

Normalized reliability=0.30×(1/1.26)=“0.24” Expert EX3:

The first calculation section 12 stores the normalized reliability information NRI that indicates the experts EX and the normalized reliabilities corresponding to the respective experts EX, in the storage section 21. The first calculation section 12 stores factor information that indicates the factor used in the normalization, in the storage section 21.

### (Step S23_3)

In step S23_3, similarly to step S23_1 described above, the derivation section 15 derives a predicted value by applying the normalized reliabilities with reference to the normalized reliability information NRI stored in the storage section 21. The derivation section 15 stores the derived predicted value in the storage section 21, or outputs it via the input/output section 22 or the communication section 23.

### (Step S24_3)

In step S24_3, the obtaining section 16 obtains loss values, similarly to step S24_1 described above. The obtaining section 16 stores the loss value information LI that indicates the loss values in the storage section 21.

### (Step S25_3)

In step S25_3, similarly to step S25_1 described above, the updating section 13 updates the normalized reliability of each expert EX with reference to the loss value of the expert EX indicated in the loss value information LI stored in the storage section 21. For example, the updating section 13 updates the normalized reliabilities to the following values.

Normalized reliability=“0.80” Expert EX2:

Normalized reliability=“0.20” Expert EX3:

The updating section 13 updates the normalized reliability information NRI stored in the storage section 21.

### (Step S26_3)

In step S26_3, similarly to step S26_1 described above, the second calculation section 14 subjects the updated normalized reliability of each expert EX with reference to the normalized reliability information NRI and the factor information FI stored in the storage section 21, to calculate a scaled reliability.

Scaled reliability=0.80×1.26=1.01 Expert EX2:

Scaled reliability=0.20×1.26=0.25 Expert EX3:

As described above, in a case where the expert EX1 (and the expert EX4) are removed, the information processing apparatus 1A normalizes the reliability of each of the remaining experts EX2 and EX3, and derives (decision making) a predicted value by applying the normalized reliabilities. Further, the information processing apparatus 1A performs scaling of the updated reliabilities, sets the scaled reliabilities as the reliabilities of the respective experts EX, and normalizes the set reliabilities again. Then, the information processing apparatus 1A repeats the process of deriving a predicted value using the normalized reliabilities.

Therefore, even in a case where the expert EX1 is removed, the information processing apparatus 1A can derive a predicted value suitably reacting to the removal of the expert EX1 by repeating the normalization of the reliabilities and the scaling of the normalized reliabilities updated. Further, the information processing apparatus 1A can derive a predicted value suitably reacting to the removal of the expert EX1, without recognizing the total number of experts EX.

### (Example Advantages of Information Processing Apparatus 1A)

As in the foregoing, even in a case where an expert EX is added or removed, the information processing apparatus 1A can derive a predicted value reacting to the addition or removal of the expert EX by repeating the normalization of the reliabilities and the scaling of the normalized reliabilities updated.

Further, the information processing apparatus 1A can derive a predicted value reacting to the addition or removal of the expert EX, without recognizing the total number of experts EX.

### (First Application Example of Information Processing Apparatus 1A)

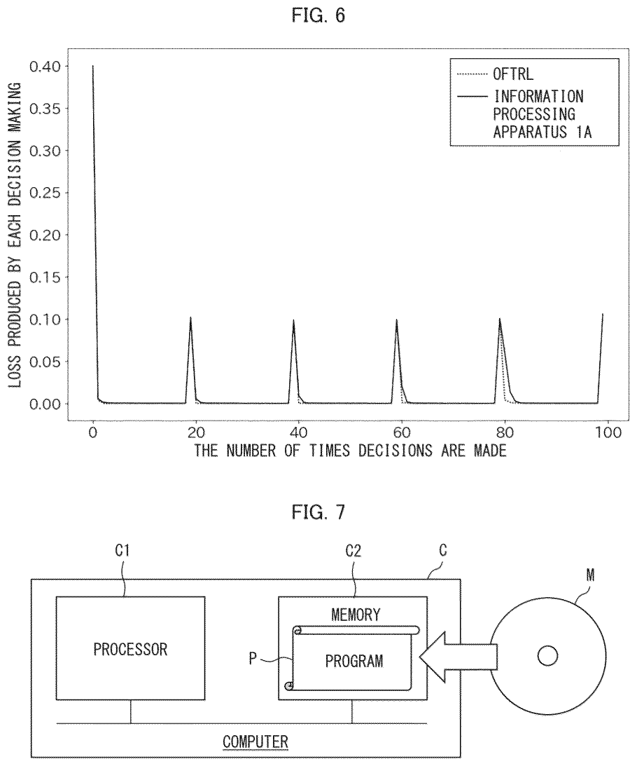

An example of applying the information processing apparatus 1A will be described with reference to FIG. 6. FIG. 6 is a graph illustrating the performance of the information processing apparatus 1A.

In a case where the information processing apparatus 1A is made to make a decision based on the following conditions, the loss value is as illustrated in a graph of FIG. 6.
The initial number of experts is 5.
Increase the number of experts by one every 10 decisions.
The expert's mean loss is constant and a better expert is added
The mean loss decreases from 1.0 in decrements of 0.1, and there is a noise selected from a uniform distribution of [−0.1, 0.1]

FIG. 6 illustrates comparison with a loss value of a decision-making apparatus which is an apparatus related to the information processing apparatus 1A and which includes Optimistic Follow The Regularized Leader (OFTRL) and sleeping experts (hereinafter, referred to as the “comparative apparatus”). As illustrated in FIG. 6, the information processing apparatus 1A has almost the same performance as that of the comparative apparatus.

Further, the volume of data to be stored by the information processing apparatus 1A decreases (or is improved) by a log 2T times (T is the number of times decisions are made) compared with that of the comparative apparatus. Therefore, although the performance of the information processing apparatus 1A does not differ from that of the comparative apparatus, the volume of data to be stored is small, so that it is possible to derive a predicted value suitably reacting to the addition of an expert EX.

### (Second Application Example of Information Processing Apparatus 1A)

The information processing apparatus 1A is applicable to a technique called Mixture of Experts (MoE), which is one of techniques to achieve high-precision data generation by combining multiple language models. By applying the information processing apparatus 1A to this technique, it is possible to determine the optimum reliability of each language model with reference to user feedback on output of each language model.

Specifically, first, the information processing apparatus 1A obtains, from the multiple language models (experts), output (e.g., an answer to a question, generation of sentences, or the like) in response to input. Next, the information processing apparatus 1A obtains user feedback on output of each language model (e.g., evaluation on the quality and usefulness of output and the like). The information processing apparatus 1A updates the reliability of each language model with reference to a loss value obtained from the user feedback. This can increase the influence (or increase the reliability) of a language model that provides a useful output for the user.

As an example, the obtaining section 16 obtains, from each language model, output in response to input. Next, the obtaining section 16 presents the obtained output of each language model to the user via the input/output section 22, and obtains user feedback on the output of the language model via the input/output section 22. The updating section 13 updates the normalized reliability of each language model with reference to a loss value obtained by referring to user feedback on the output of the language model.

The processing in which the second calculation section 14 subjects the normalized reliability updated by the updating section 13 to scaling, to calculate the reliability, and the setting section 11 sets in the next round the scaled reliability, subjected to scaling by the second calculation section 14, for each language model, is as described above.

Thus, even if a language model is newly added or removed, the information processing apparatus 1A can adjust parameters of multiple language models to an optimum combination while utilizing user feedback, to provide the most useful output for the user.

### [Software Implementation Example]

Some or all of functions of the information processing apparatuses 1 and 1A (hereinafter, also referred to as “the abovementioned apparatuses”) may be realized by hardware such as an integrated circuit (IC chip) or may be alternatively realized by software.

In the latter case, each of the abovementioned apparatuses is implemented by, for example, a computer that executes instructions of a program that is software implementing the functions. FIG. 7 illustrates an example of such a computer (hereinafter, referred to as “computer C”). FIG. 7 is a block diagram illustrating the hardware configuration of the computer C that functions as the abovementioned apparatuses.

The computer C includes at least one processor C1 and at least one memory C2. The memory C2 stores a program P for causing the computer C to function as the abovementioned apparatuses. The processor C1 of the computer C retrieves the program P from the memory C2 and executes the program P, so that the functions of the abovementioned apparatuses are implemented.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 can be, for example, a flash memory, a hard disk drive (HDD), a solid state drive (SSD), or a combination of these.

Note that the computer C may further include a random access memory (RAM) in which the program P is loaded if the program P is executed and/or in which various kinds of data are temporarily stored. The computer C may further include a communication interface via which data is transmitted to and received from another apparatus. The computer C may further include an input-output interface for connecting input-output apparatuses such as a keyboard, a mouse, a display and a printer.

The program P can be recorded in a non-transitory tangible storage medium M from which the computer C can read the program P. The storage medium M can be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can acquire the program P also via such a transmission medium.

### [Additional Remark A]

The present disclosure includes techniques described in supplementary notes below. Note, however, that the present invention is not limited to the techniques described in supplementary notes below, but may be altered in various ways within the scope of the claims.

### (Supplementary Note A1)

An information processing apparatus including:
setting means for setting a reliability for each of a plurality of experts;
first calculation means for normalizing the reliability of each of the plurality of experts, to calculate a normalized reliability;
updating means for updating the normalized reliability of each of the plurality of experts with reference to a loss value of the expert obtained in a case where prediction is performed applying the normalized reliability; and
second calculation means for subjecting the updated normalized reliability of each of the plurality of experts to scaling, to calculate a scaled reliability,
wherein the setting means
   sets a predetermined value as a reliability of a newly added new expert, and
   sets the scaled reliability as a reliability of an existing expert.

### (Supplementary Note A2)

The information processing apparatus according to Supplementary note A1, wherein the second calculation means performs scaling with use of a reciprocal of a factor used in the normalization performed by the first calculation means.

### (Supplementary Note A3)

The information processing apparatus according to Supplementary note A1 or A2, wherein
each of the plurality of experts is a language model, and
the updating means updates the normalized reliability of each language model with reference to a loss value obtained by referring to user feedback on output of the language model.

### [Additional Remark B]

The present disclosure includes techniques described in supplementary notes below. Note, however, that the present invention is not limited to the techniques described in supplementary notes below, but may be altered in various ways within the scope of the claims.

### (Supplementary Note B1)

An information processing method including:
a setting process of setting, by at least one processor, a reliability for each of a plurality of experts;
a first calculation process of normalizing, by the at least one processor, the reliability of each of the plurality f experts, to calculate a normalized reliability;
an updating process of updating, by the at least one processor, the normalized reliability of each of the plurality of experts with reference to a loss value of the expert obtained in a case where prediction is performed applying the normalized reliability; and
a second calculation process of subjecting, by the at least one processor, the updated normalized reliability of each of the plurality of experts to scaling, to calculate a scaled reliability,
wherein in the setting process, the at least one processor
   sets, as a reliability of a newly added new expert, a predetermined value, and
   sets, as a reliability of an existing expert, the scaled reliability.

### (Supplementary Note B2)

The information processing method according to Supplementary note B1, wherein in the second calculation process, the at least one processor performs scaling with use of a reciprocal of a factor used in the normalization of the first calculation process.

### (Supplementary Note B3)

The information processing method according to Supplementary note B1 or B2, wherein
each of the plurality of experts is a language model, and
in the updating process, the at least one processor updates the normalized reliability of each language model with reference to a loss value obtained by referring to user feedback on output of the language model.

### [Additional Remark C]

The present disclosure includes techniques described in supplementary notes below. Note, however, that the present invention is not limited to the techniques described in supplementary notes below, but may be altered in various ways within the scope of the claims.

### (Supplementary Note C1)

An information processing program that causes a computer to function as an information processing apparatus, the information processing program causing the computer to function as:
setting means for setting a reliability for each of a plurality of experts;
first calculation means for normalizing the reliability of each of the plurality of experts, to calculate a normalized reliability;
updating means for updating the normalized reliability of each of the plurality of experts with reference to a loss value of the expert obtained in a case where prediction is performed applying the normalized reliability; and
second calculation means for subjecting the updated normalized reliability of each of the plurality of experts to scaling, to calculate a scaled reliability,
wherein the setting means
   sets a predetermined value as a reliability of a newly added new expert, and
   sets the scaled reliability as a reliability of an existing expert.

### (Supplementary Note C2)

The information processing program according to Supplementary note C1, wherein the second calculation means performs scaling with use of a reciprocal of a factor used in the normalization performed by the first calculation means.

### (Supplementary Note C3)

The information processing program according to Supplementary note C1 or C2, wherein
each of the plurality of experts is a language model, and
the updating means updates the normalized reliability of each language model with reference to a loss value obtained by referring to user feedback on output of the language model.

### [Additional Remark D]

The present disclosure includes techniques described in supplementary notes below. Note, however, that the present invention is not limited to the techniques described in supplementary notes below, but may be altered in various ways within the scope of the claims.

### (Supplementary Note D1)

An information processing apparatus including at least one processor, the at least one processor carrying out:
a setting process of setting a reliability for each of a plurality of experts;
a first calculation process of normalizing the reliability of each of the plurality of experts, to calculate a normalized reliability;
an updating process of updating the normalized reliability of each of the plurality of experts with reference to a loss value of the expert obtained in a case where prediction is performed applying the normalized reliability; and
a second calculation process of subjecting the updated normalized reliability of each of the plurality of experts to scaling, to calculate a scaled reliability,
wherein in the setting process, the at least one processor
   sets a predetermined value as a reliability of a newly added new expert, and
   sets the scaled reliability as a reliability of an existing expert.

Here, the information processing apparatus may further include a memory. Further, the memory may store a program for causing the at least one processor to carry out each of the processes.

### (Supplementary Note D2)

The information processing apparatus according to Supplementary note D1, wherein in the second calculation process, the at least one processor performs scaling with use of a reciprocal of a factor used in the normalization of the first calculation process.

### (Supplementary Note D3)

The information processing apparatus according to Supplementary note D1 or D2, wherein
each of the plurality of experts is a language model, and
in the updating process, the at least one processor updates the normalized reliability of each language model with reference to a loss value obtained by referring to user feedback on output of the language model.

### [Additional Remark E]

The present disclosure includes techniques described in supplementary notes below. Note, however, that the present invention is not limited to the techniques described in supplementary notes below, but may be altered in various ways within the scope of the claims.

### (Supplementary Note E1)

A non-transitory storage medium storing an information processing program that causes a computer to function as an information processing apparatus,
the information processing program causing the computer to carry out:
a setting process of setting a reliability for each of a plurality of experts;
a first calculation process of normalizing the reliability of each of the plurality of experts, to calculate a normalized reliability;
an updating process of updating the normalized reliability of each of the plurality of experts with reference to a loss value of the expert obtained in a case where prediction is performed applying the normalized reliability; and
a second calculation process of subjecting the updated normalized reliability of each of the plurality of experts to scaling, to calculate a scaled reliability,
in the setting process, the computer
   sets a predetermined value as a reliability of a newly added new expert, and
   sets the scaled reliability as a reliability of an existing expert.

### REFERENCE SIGNS LIST

1, 1A Information processing apparatus
11 Setting section
12 First calculation section
13 Updating section
14 Second calculation section
15 Derivation section
16 Obtaining section
FI Factor information
LI Loss value information
NRI Normalized reliability information
RI Reliability information

1. An information processing apparatus comprising at least one processor, the at least one processor carrying out:
a setting process of setting a reliability for each of a plurality of experts;
a first calculation process of normalizing the reliability of each of the plurality of experts, to calculate a normalized reliability;
an updating process of updating the normalized reliability of each of the plurality of experts with reference to a loss value of the expert obtained in a case where prediction is performed applying the normalized reliability; and
a second calculation process of subjecting the updated normalized reliability of each of the plurality of experts to scaling, to calculate a scaled reliability,
wherein in the setting process,
as a reliability of a newly added new expert, the at least one processor sets a predetermined value, and
as a reliability of an existing expert, the at least one processor sets the scaled reliability.

2. The information processing apparatus according to claim 1, wherein in the second calculation process, the at least one processor performs scaling with use of a reciprocal of a factor used in the normalization of the first calculation process.

3. The information processing apparatus according to claim 1, wherein
each of the plurality of experts is a language model, and
in the updating process, the at least one processor updates the normalized reliability of each language model with reference to a loss value obtained by referring to user feedback on output of the language model.

4. An information processing method comprising:
a setting process of setting, by at least one processor, a reliability for each of a plurality of experts;
a first calculation process of normalizing, by the at least one processor, the reliability of each of the plurality of experts, to calculate a normalized reliability;
an updating process of updating, by the at least one processor, the normalized reliability of each of the plurality of experts with reference to a loss value of the expert obtained in a case where prediction is performed applying the normalized reliability; and
a second calculation process of subjecting, by the at least one processor, the updated normalized reliability of each of the plurality of experts to scaling, to calculate a scaled reliability,
wherein in the setting process, the at least one processor
sets, as a reliability of a newly added new expert, a predetermined value, and
sets, as a reliability of an existing expert, the scaled reliability.

5. A computer-readable non-transitory storage medium storing an information processing program that causes a computer to function as an information processing apparatus,
the program causing the computer to carry out:
a setting process of setting a reliability for each of a plurality of experts;
a first calculation process of normalizing the reliability of each of the plurality of experts, to calculate a normalized reliability;
an updating process of updating the normalized reliability of each of the plurality of experts with reference to a loss value of the expert obtained in a case where prediction is performed applying the normalized reliability; and
a second calculation process of subjecting the updated normalized reliability of each of the plurality of experts to scaling, to calculate a scaled reliability,
wherein in the setting process,
as a reliability of a newly added new expert, a predetermined value is set, and
as a reliability of an existing expert, the scaled reliability is set.
